(19) United States
(12) Patent Application Publication
(10) Pub. No.: US 2006/0151915 A1
(43) Pub. Date: Jul. 13, 2006

(54) Machine and process for fusion molding of plastic single-use containers

(76) Inventors: Darrell Van Dyke, Libertyville, IL (US); F. Jack Beutlich, Waukegian, IL (US)

Correspondence Address: Michael S. Leonard;EVEREST INTELLECTUAL PROPERTY LAW GROUP, P.O. Box 708, Northbrook, IL, 60065, US

(21) Appl. No.: 11/210,454

(22) Filed: Aug. 24, 2005

Related U.S. Application Data
(60) Provisional application No. 60/604,125, filed on Aug. 24, 2004.

(51) Int. Cl. B28B 1/38

(52) U.S. Cl. 264/304; 264/338; 425/269

(57) ABSTRACT

A machine and process for mass-manufacturing hollow plastic articles using a plurality of rotating mandrels in a single cassette head comprising the steps of coating the mandrels with a mold release formulation, heating the mandrels, immersing the mandrels into a fluidized bed of resin particles, heat fusing the resin coating on the mandrels, cooling the resin and the mandrels, stripping the plastic articles from the mandrels and cutting them to length. The machine has a rotating portion comprising several identical mandrel-containing heads and a stationary portion comprising an equal number of workstations, each workstation adapted to perform one of the process steps, the rotating portion simultaneously moving all of the mandrel-containing heads to interact sequentially with one workstation after another wherein each of the process steps is executed in turn.

This application claims priority of U.S. provisional patent application No. 60/604,125 filed Aug. 24, 2004, incorporated by reference in its entirety.

### BACKGROUND OF THE INVENTION

The invention relates to a machine and process for the manufacture of plastic containers of generally tubular or cylindrical shape, the articles being symmetrical about a central axis. More specifically, the invention relates to a mass-production machine designed to repeatedly execute a multi-step process for dip molding, finishing, cooling, drying, and cutting to size variously sized plastic containers having geometric shapes that allow the articles to be slidably removable from the mandrels on which they are formed.

The manufacture of hollow plastic articles by dipping a mandrel into a plastic material, allowing the material to harden into a solid article, and then removing the article from the mandrel, is well know in the prior art. For example, U.S. Pat. No. 2,966,703 [Harman] and U.S. Pat. No. 2,983,959 [Shapero] disclose various methods in which the mandrel is dipped into a liquid bath of heated thermoplastic material.

Other disclosures used a heated mandrel inserted into a fluidized bed of solid plastic particles, with the particles being heated by the mandrel to above the melting temperature of the plastic so that the plastic particles cling to the mandrel and fuse to each other to form a unitary article. Exemplary disclosures include those of U.S. Pat. No. 3,002,231 [Walker] and U.S. Pat. No. 4,138,132 [Doyle].

A similar but notably distinguished process is disclosed in U.S. Pat. No. 3,927,161 [Powell], which discloses a process of manufacturing a foam filled plastic resin article comprising the steps of creating a fluidized bed of vinyl plastic particles, preheating a mold shaped as desired for a skin to be formed therein, immersing and rotating the mold in the bed to form a vinyl plastic skin in the mold, removing the mold from the bed and heat curing the skin still within the mold, cooling the mold, and stripping the skin from the mold. The critical difference between the Powell process and the process of the present invention is that the Powell process discloses an external mold with the skin formed therein, whereas the present invention utilizes an internal mandrel with the skin formed on the outside thereof. Additionally, the Powell process rotates the mold only during the coating step and the process of the present invention continually rotates the mandrel through all process steps (except the stripping step) in order to achieve uniformity, speed of production, and increased wall thickness of the final plastic article.

Most pertinent is U.S. Pat. No. 5,229,061 [Van Dyke] which discloses a method for making a hollow plastic article comprising the steps of providing a fluidized bed of meltable particulate resinous material, heating a mandrel to the melting temperature of the resinous material, immersing the mandrel into the fluidized bed to coat the mandrel, removing the mandrel from the bed, heating the coated mandrel again, cooling the coating on the mandrel, and stripping the coating as a hollow article from the mandrel. Importantly, the mandrel in this earlier disclosed process is fixed and does not rotate during any of the process steps, as compared with the process of the present invention whereby the mandrel rotates continuously during each process step except during the stripping of the article from the mandrel.

It is, therefore, an object of the present invention to provide a machine and process for manufacturing hollow plastic articles using a dip molding process that repeatedly yields uniform and high quality product. It is further an object of the present invention to provide a machine and process for manufacturing hollow plastic articles that enables production of a large quantity of finished product in a short amount of time. It is an additional object of the present invention to provide a machine and process for manufacturing hollow plastic articles that improves upon the previously existing processes by adding the action of continually rotating the mandrels on which the plastic articles are formed during the manufacturing process.

Other objects will appear hereinafter.

### SUMMARY OF THE INVENTION

A process is disclosed for manufacturing hollow plastic articles and a machine for automating that process to rapidly and repeatably produce large quantities of said plastic articles. The process involves the dip molding of resin onto a plurality of rotating mandrels and comprises steps of coating the mandrels with a mold release formulation, heating the mandrels to a temperature at or above the melting temperature of the resin to be molded, immersing the mandrels into a fluidized bed of resin particles to coat the mandrels, heating the coated mandrels to improve the external surface finish of the resin coating, cooling the resin and the mandrels to rigidify the plastic hollow articles, and stripping the plastic articles from the mandrels and cutting them to length.

The machine designed particularly for executing the process of the present invention comprises a stationary vertical central shaft surrounded by twelve fixed process stations each equally spaced around a full circle at a fixed radius from the shaft and a rotor assembly rotatably mounted on the vertical shaft and supporting twelve identical heads each spaced equally around a full circle of the same radius as that of the fixed process stations. Each of the twelve identical heads includes a plurality of mandrels carried in a cassette, the cassette being slidably mounted in the head to be automatically actuated in the vertical direction so that the mandrels may be lowered to interact with each process station and raised as the rotor assembly rotates each head from one station to the next as part of the sequential manufacturing process.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a photograph showing an overview of the fusion-molding machine of the present invention.

FIG. 2 is a photograph showing the mold release station of the fusion-molding machine of the present invention.

FIG. 3 is a photograph showing the mold release blow-off station of the fusion-molding machine of the present invention.

FIG. 4 is a photograph showing the induction heater station of the fusion-molding machine of the present invention.

FIG. 5 is a photograph showing the fluidized powder resin bed station of the fusion-molding machine of the present invention.

FIG. 6 is a photograph showing the radiant heating station of the fusion-molding machine of the present invention.

FIG. 7 is a photograph showing the cooling water bath station of the fusion-molding machine of the present invention.

FIG. 8 is a photograph showing the stripper station of the fusion-molding machine of the present invention.

FIG. 9 is a photograph showing a close-up of the mandrels entering the mold resin dip bath of the fusion-molding machine of the present invention.

FIG. 10 is a photograph showing a close-up of the mandrels entering the mold release air knife of the fusion-molding machine of the present invention.

FIG. 11 is a photograph showing a close-up of the mandrels entering the radiant heater station of the fusion-molding machine of the present invention.

FIG. 12 is a schematic view showing the step-by-step process for making plastic articles of one embodiment of the fusion-molding machine of the present invention.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

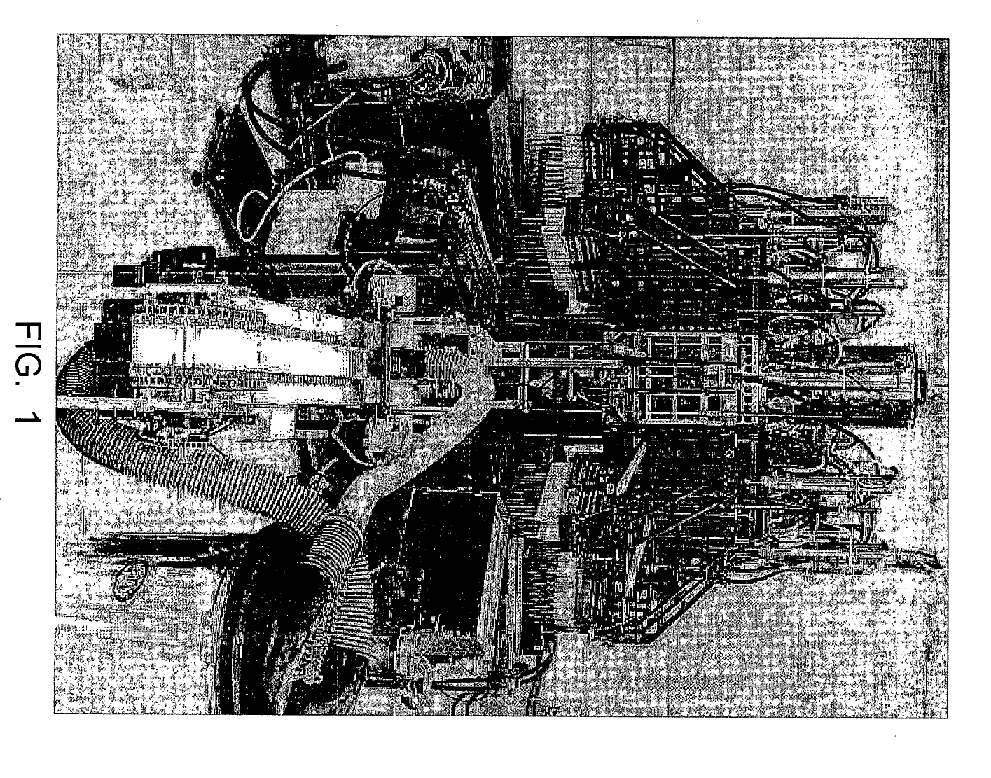

Referring now to the drawings in detail, where like numerals refer to like parts or elements, there is shown in FIG. 1 an overview of the fusion molding machine of the present invention. The machine comprises twelve identical heads mounted to a motorized rotor assembly rotatably centered on a stationary vertical shaft, the twelve heads cooperating with twelve workstations each performing a different sequential function in the operation of the machine. Each of the twelve identical heads includes a plurality of mold mandrels mounted to a cassette that can be actuated mechanically, hydraulically, or pneumatically in the vertical direction so that the mandrels can interact with each of the workstations. Between each sequential step of the operation of the machine, the rotor assembly is rotated about the central vertical shaft by 30 degrees so that each head can interact, in order, with each of the workstations that are evenly spaced around the central shaft at a fixed radial distance. The cassettes are in their fully raised position during the rotation of the rotor assembly from one station to the next and are lowered at a prescribed rate when the rotor is stopped so that the mandrels can interact with each process station. After being held in their fully lowered position for a prescribed period of time associated with each workstation, the cassettes are raised at a prescribed rate in preparation for rotation of the rotor assembly to the next workstation and sequential process step.

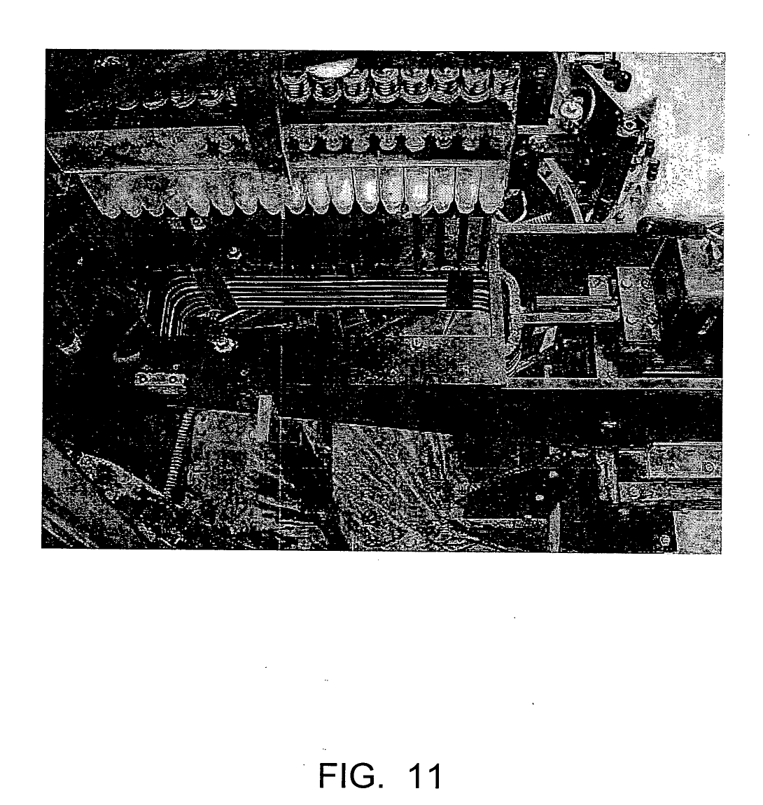

Each of the identical heads comprises a framework, vertical head actuation means, and a plurality of rotating mold mandrels. Referring to FIGS. 1, 6, and 11 in combination, it can be seen that the illustrated embodiment of the fusion molding machine has a total of thirty-four mandrels in each head, arranged in two rows of seventeen each. FIG. 11, in particular, shows the gears that partially comprise the mandrel rotating means that provide for the rotation of each mandrel within the head. The mandrels and the mandrel rotating means are contained within a cassette that is slidably retained within the framework of the head. A vertical actuator, with its fixed housing rigidly mounted to the head framework and an end of its axially actuating shaft rigidly affixed to the slidably mounted cassette, automatically lowers and raises the cassette slidably within the head so that the rotating mandrels can be lowered to interact with each workstation as required during the sequential operation of the fusion molding machine and can then be raised for transport to the next work station.

All of the identical heads are interconnected by a ring framework to form the rotor assembly. The rotor assembly is rotated about the central shaft by a rotor rotation means. In the illustrated embodiment, the rotor rotation means is an electrical motor, but a hydraulic or pneumatic rotational actuator could function equally well. The rotor rotation means accurately and repeatably rotates the rotor assembly by exactly 30 degrees to position each head directly above each workstation, as required by the operational sequence.

Each mandrel is made from a smooth-surfaced metal having a relatively high heat capacity and coefficient of thermal conductivity, and is adapted for use in a dip-molding process utilizing a particulate fusible synthetic resinous material. In order to enable a finished molded article to be stripped off, the mandrel retains a substantially similar cross-sectional diameter from top to bottom and may be optionally tapered to a slightly smaller cross-section at the bottom than at the top thereof. Because an important distinguishing feature of the process of the present invention is the continual spinning or rotation of the plurality of mandrels throughout the manufacturing process, the cross-section of the mandrel is symmetrical about the vertical axis of rotation. However, a mandrel may be of dissimilar cross-section at different points along its length, as long as the cross-sectional area remains the same or decreases going downward along its length. Generally, such a mandrel will be utilized to make a simple hollow plastic article such as a tube, applicator, or syringe body, but can make more complex shapes within the parameters set out herein.

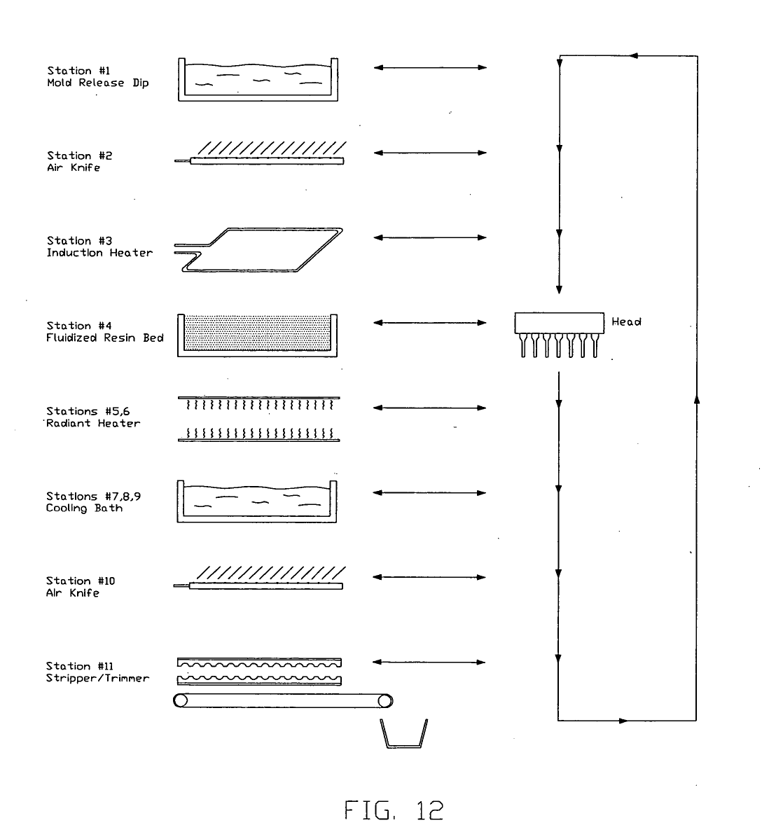

The operational sequence to manufacture plastic articles (e.g., containers, tubes, or more complex functional shapes) with the fusion molding machine of the present invention, illustrated schematically in FIG. 12, comprises the steps of: coating the mandrels with mold release formulation, blowing off excess mold release formulation, heating the mandrels, coating the hot mandrels with resin, externally heating the resin on the mandrels, cooling the resin and the mandrels, blowing off excess water from the plastic articles, and stripping the formed plastic articles from the mandrels. It is important to note that all of the mandrels continue to rotate throughout every step of the process except for the stripping step, yielding advantages at each operational step that are described herein. Between each step, the mandrels are raised and the rotor assembly is rotated by 30 degrees so that each head moves sequentially through each of the required operational steps of the manufacturing process.

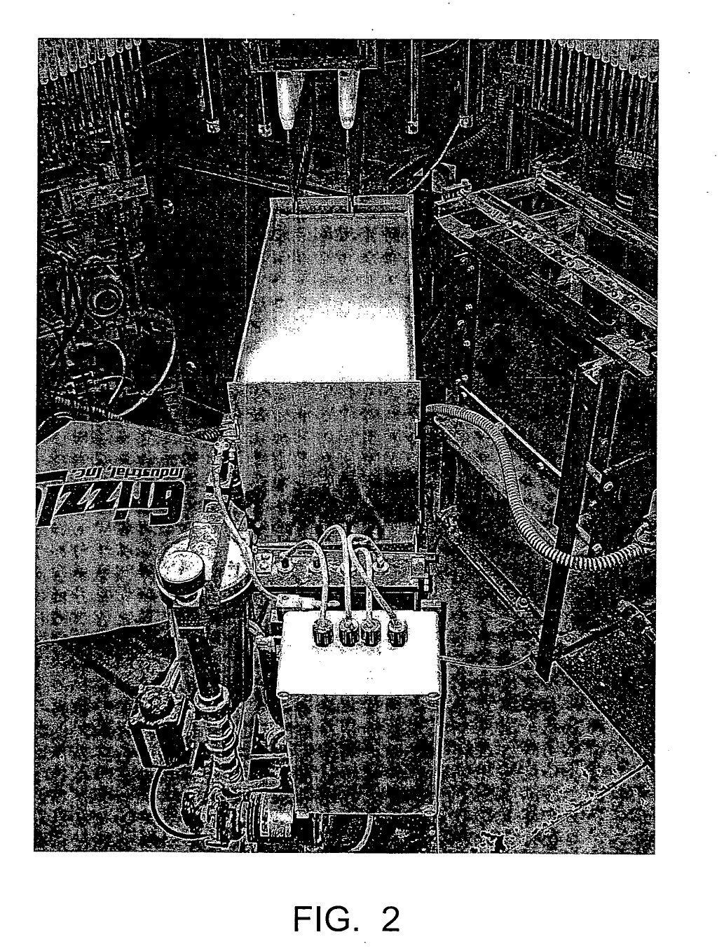

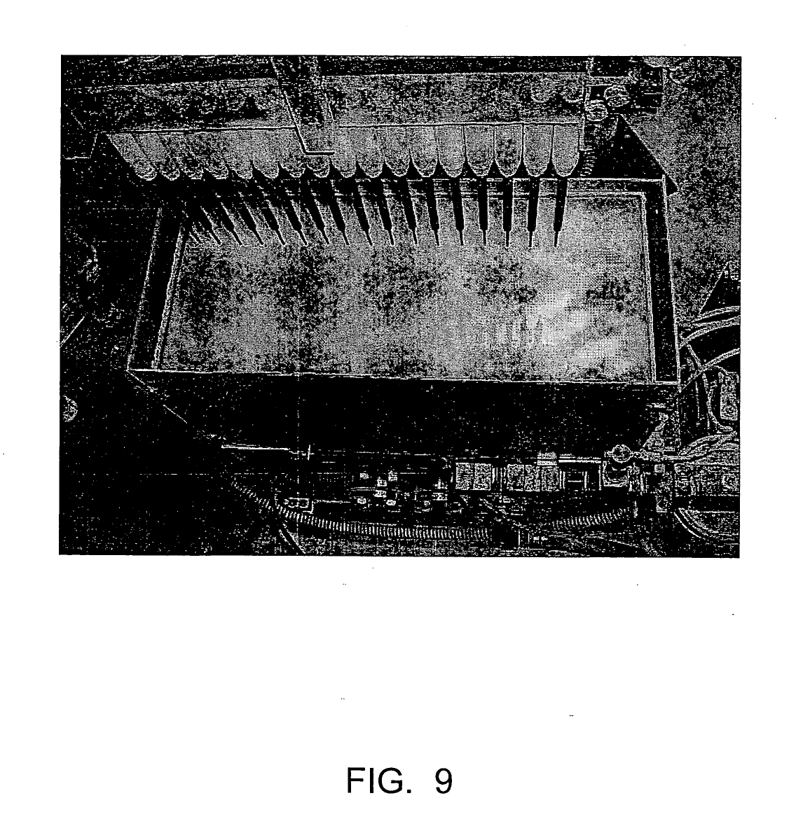

The first step in the fusion molding process is coating the mandrels with mold release formulation. This step is illustrated in FIG. 2, showing the mandrels poised above station 1, the mold release bath station. FIG. 9 shows a closer view of the mandrels awaiting dipping at station 1. Here, the rotating mandrels are dipped into the mold release formulation, coating the mandrels uniformly along their length. The thin coating of mold release formulation applied in station 1 eases the stripping of the plastic articles from the mandrels at station 11. The rotation of the mandrels during the dipping process improves the uniformity of the coating and the speed at which this process step can take place. After the mandrels are raised from the bath, the rotor assembly is ready to proceed forward one step.

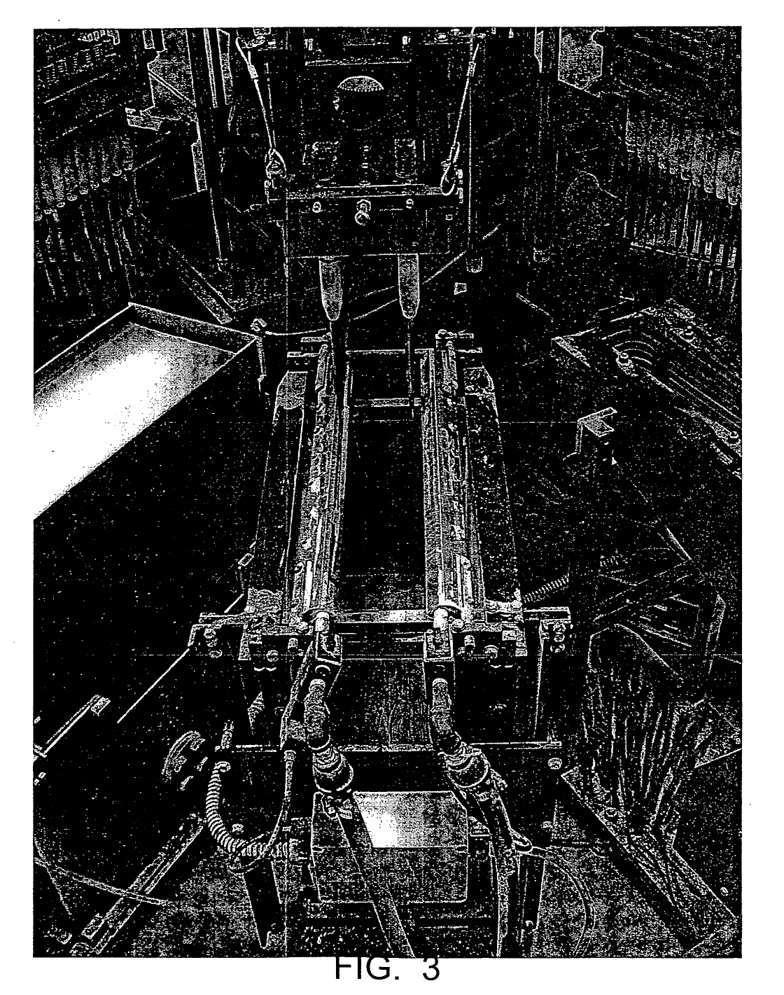

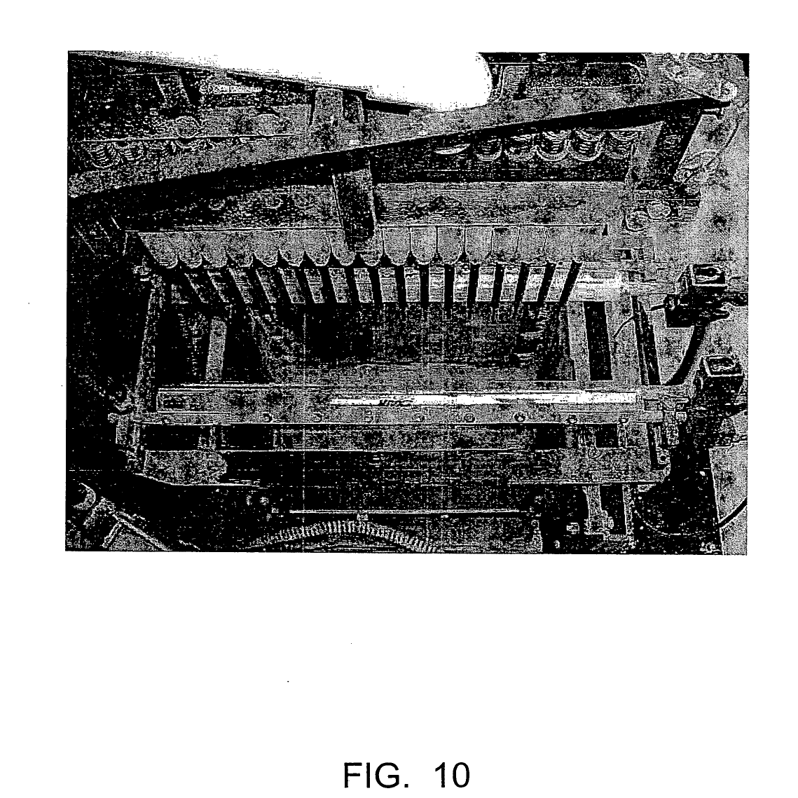

The second step in the fusion molding process is the blowing off of any excess mold release formulation. This step is illustrated in FIG. 3, showing the mandrels poised above station 2, the mold release air knife station. FIG. 10 shows a closer view of the mandrels awaiting the removal of excess mold release formulation. Here, the rotating mandrels are passed across two opposed air knives, or narrow sheets of pressurized air. The spinning of the mandrels as they are vertically actuated through these sheets of air enables the stationary air knives to completely blow off excess mold release formulation from the mandrels, leaving a thin, even coating. Once the excess mold release formulation has been removed from the mandrels, they are ready for pre-heating before being dipped in the powdered resin.

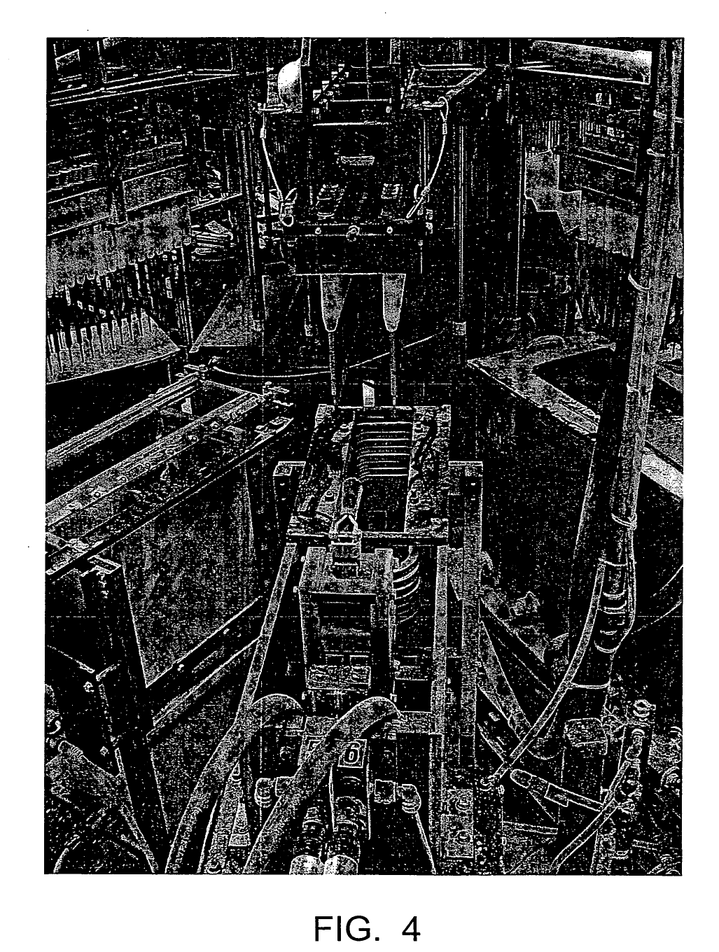

The third step in the fusion molding process is the heating of the mandrels by induction heaters to a temperature at or slightly above the melting temperature of the resin from which the plastic articles will be made. A typical temperature to which the mandrels are heated is approximately 400° F., depending on the particular plastic resin being used. This step is illustrated in FIG. 4, showing the mandrels poised above station 3, the induction heating station. FIG. 11 gives a closer view of the induction coils surrounding the space in workstation 3 into which the mandrels will be lowered for heating. The electromagnetic field created by the induction heater coils heats the mandrels. Because the heaters only surround the perimeter of the set of mandrels, the spinning of the mandrels plays an important role in uniformly and quickly heating the entire surface of each of the mandrels. After the mold-release-formulation-coated mandrels are heated, they are ready to proceed to the resin dipping step.

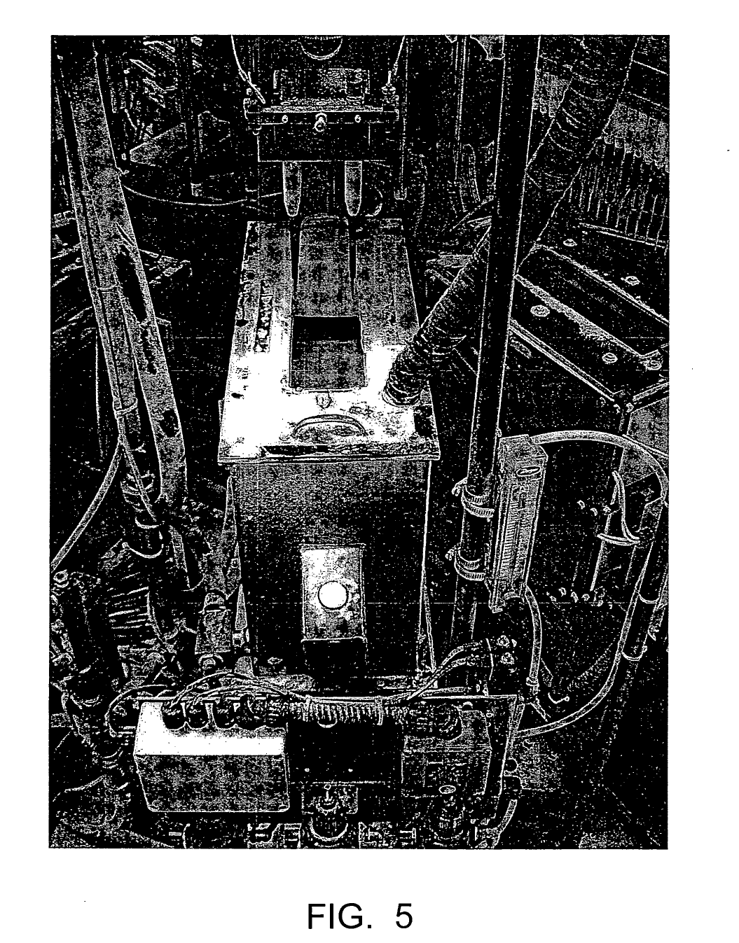

The fourth step in the fusion molding process is the coating of the hot mandrels with resin. This step is illustrated in FIG. 5, showing the mandrels poised above station 4, awaiting dipping in the fluidized powder resin bed. The fluidized bed comprises meltable particulate resinous material. The resin bed is fluidized by blowing filtered air through the bottom of the bed and by vibrating the bed. A variety of synthetic resinous materials may be utilized, the selection of which will be evident to those skilled in the art. The resin must have a sufficiently low melt viscosity to permit coverage of all mandrel surfaces, and it must produce a non-porous and pinhole-free structure. The polymer will normally be a thermoplastic, and exemplary materials include polypropylene, high-density polyethylene, rigid polyvinyl chloride, and nylon. The continued rotation of the mandrels as they are dipped into the fluidized powder resin bed is critical for increasing both wall thickness and uniformity of the plastic article being formed. Spinning of the mandrels enables the manufacture of thicker articles in shorter dip times, while at the same time improving quality. Because the mandrels are hot, the powdered resin particles adhere to the mandrels and fuse to each other to form a unitary article. The mandrels are coated uniformly with resin along the entire length thereof that is immersed in the fluidized bed. Upon completion of this step, the resin-coated mandrels are ready for the finishing of the outside surface of the resin to create high quality plastic articles.

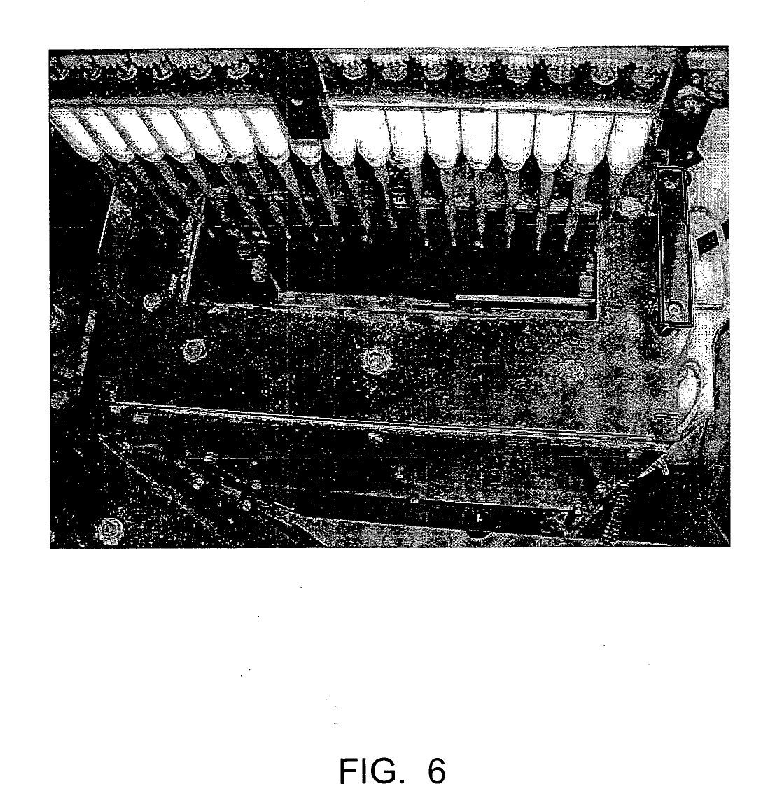

The fifth step in the fusion molding process is the external heating of the resin on the mandrels. This step is illustrated in FIG. 6 showing the mandrels poised above stations 5 and 6, awaiting exposure to the radiant heaters located therein. External heating of the resin adhered to the mandrels continues the fusing process among the particles and results in an even, uniform plastic coating on the mandrels. The heating step smoothes the outer surface of the plastic articles being formed; two consecutive heating steps are used in the present embodiment to provide both complete fusing of the particles and additional smoothing of the final article outer surface. The rotation of the mandrels during their exposure to the radiant heaters is essential to ensure uniform heating of the outer surface of the resin and therefore a consistent smoothness of the external surface of the final plastic article. Once the external surface of the plastic articles has been finished, the rotor assembly is ready to proceed forward one step to the cooling of the articles.

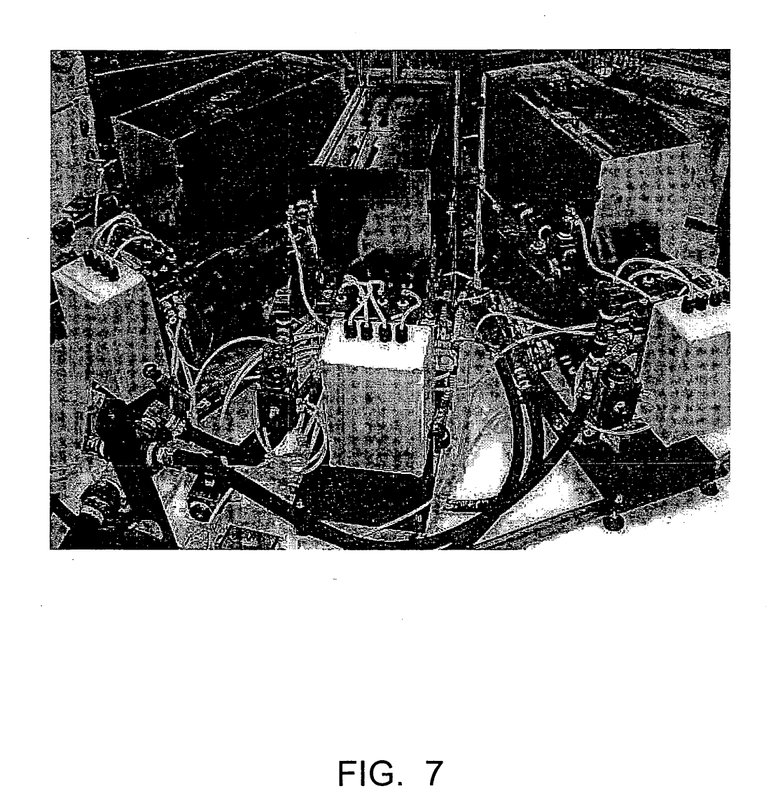

The sixth step in the fusion molding process is the cooling of the resin and the mandrels. This step is illustrated in FIG. 7, showing the mandrels poised above stations 7, 8, and 9, awaiting dipping in the cooling tanks. Cooling solidifies any still molten resin and rigidifies resin that is still warm and pliable after exposure to the radiant heaters, locking in the smooth outer surface created during the fusing of the resin particles at stations 5 and 6. In this step, the plastic articles are brought to room temperature without shrinkage to allow for easy stripping. The liquid in the cooling baths is temperature-controlled chilled water, although other non-reactive heat transfer liquids may be used. The chilled water, treated with bleach to avoid bacteria accumulation, is recirculated in a closed system to maintain a constant cooling water temperature. In the present embodiment, three successive cooling water baths are utilized to provide adequate cooling of the plastic articles to make them sufficiently cooled and hardened to be ready for stripping from the mandrels. Heat transfer away from the plastic articles into the cooling baths is made uniform and is significantly enhanced by the rotation of the mandrels during this step, and pre-empts the need for additional cooling steps or the lengthening of the time the articles are in the cooling bath. After sufficient cooling of the plastic articles and mandrels, the articles are ready for drying and removal from the mandrels.

The seventh step in the fusion molding process is the drying of the plastic articles. This step is not illustrated but is nearly identical to the mold release blow-off step shown in FIG. 3, with the mandrels poised above the air-knife. At station 10, the water blow-off station, a pair of opposed air-knives identical to those located at station 2 blow off excess water from the formed plastic articles. The continual spinning of the articles on the rotating mandrels enhances the rapidity and uniformity of the drying effect. The dry plastic articles are now completely formed and all that remains is to remove the plastic articles from the mandrels and cut them to length so that they can be inspected and packaged.

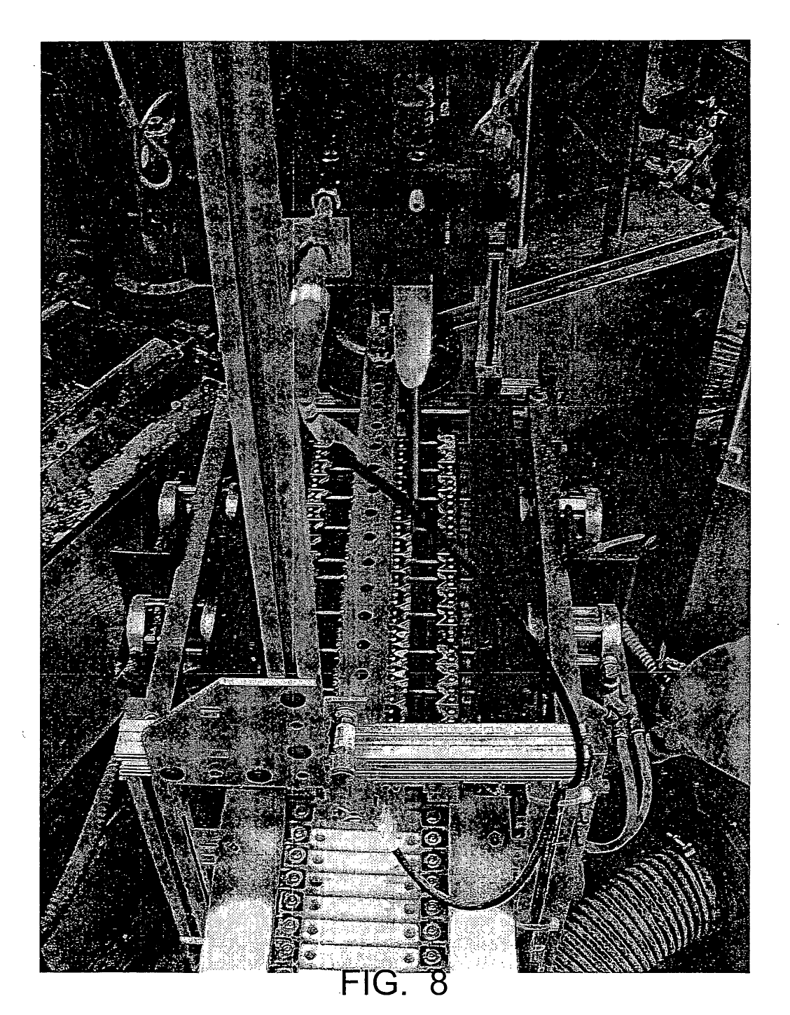

The eighth and final step in the fusion molding process is the stripping of the plastic articles from the mandrels and the trimming to length of those plastic articles. This step is illustrated in FIG. 8, showing the mandrels above the stripper located at station 11, depicted after the plastic articles have already been stripped therefrom. The stripper comprises a set of mechanical gripper jaws positioned at the appropriate height to grip the plastic articles near the upper ends thereof when the mandrel-carrying cassette is at the bottom point of its vertical travel. The gripper jaws comprise an individual gripper for each plastic article. As the cassette travels downward, the gripper jaws are opened to allow the mandrel-mounted plastic articles to pass therethrough. When the cassette reaches its bottom point of travel, the gripper jaws close on the plastic articles encasing the mandrels. The jaws remain closed as the mandrel-carrying cassette is raised, thereby stripping the plastic articles from the mandrels. The mandrels are not rotated during the stripping operation. The mold release formulation applied to the bare mandrels in step 1, prior to the forming of the plastic articles, enables the articles to slide easily away the mandrels. Also, during the cooling process, the differential coefficient of thermal expansion between the metal mandrels and the plastic articles results in a decreased frictional force therebetween, thereby easing the stripping operation. Once the cassette is raised, the gripper jaws open, dropping each plastic article into an individual nest in a conveyor. The conveyor moves the plastic articles under rotating circular knives that trim off a small amount of excess unusable material away from the top of each plastic article. The trimmed, completed plastic articles are carried away on the conveyor and dropped into a bulk bin before being subject to quality inspection and packaging.

As currently designed, the fusion molding machine of the present invention includes a spare work station, station 12, which is not utilized but is available in the event that an additional process step is needed for a particular manufacturing process. At present, this station allows for a short rest period during which the operator may inspect the mandrels for any damage that may affect the quality of the plastic articles. It is noted here that the number of process stations can be altered from twelve without changing the principle features of the present invention. For example, if it is determined that only two cooling steps are required instead of three, or that three resin dipping steps are desirable instead of one, the present embodiment of the invention could be modified to include ten or thirteen heads and workstations, respectively (not counting any additional stations that may be otherwise designated or left as spares). While it may be conceded that a minimum number of heads and stations may be required to achieve each of the required disclosed process steps for a continuous manufacturing process, the maximum number of heads and stations that can be comprised in the machine of the present invention is limited only by physical space constraints.

In sum, the machine and process of the present invention enables continuous and repeatable production of large quantities of hollow plastic articles (tubes or containers or the like) at high rates of speed, conveniently and inexpensively, while ensuring that each plastic article is uniform and exhibits the desired physical shape and characteristics.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A machine for making plastic containers, comprising:
a mold release formulation station;
a mold heating station after the mold release formulation station;
a resin dipping container station after the mold heating station;
a resin heating station after the resin dipping container station;
a cooling station after the resin heating station; and
a stripping station after the resin cooling srtation.

2. A method of making plastic devices, comprising:
applying a mold release to a dip mold;
heating the dip mold;
dipping the dip mold in a container of resin;
removing the dip mold from the container of resin;
heating resin on the dip mold;
cooling the resin on the dip mold; and
removing the cooled resin from the dip mold.
